(19) United States
(12) Patent Application Publication
(10) Pub. No.: US 2012/0282130 A1
(43) Pub. Date: Nov. 8, 2012

(54) Method for producing permanent magnet materials and resulting materials

(75) Inventors: Karl A. Gschneidner, JR., Ames, IA (US); Frederick A. Schmidt, Ames, IA (US); Ralph W. McCallum, Ames, IA (US)

(73) Assignee: Iowa State University Research Foundation, Inc.

(21) Appl. No.: 13/506,427

(22) Filed: Apr. 18, 2012

Related U.S. Application Data
(63) Continuation of application No. PCT/US2010/002847, filed on Oct. 27, 2010.
(60) Provisional application No. 61/280,198, filed on Oct. 30, 2009.

(51) Int. Cl. H01F 1/01; B22F 1/00; C22C 38/00; B22F 9/00

(52) U.S. Cl. 419/30; 75/433; 75/392; 75/351; 419/63; 420/591; 420/83

(57) ABSTRACT

A carbothermic reduction method is provided for reducing a rare earth element-containing oxide including at least one of neodymium (Nd) and praseodymium (Pr) and possibly other rare earth elements (La, Ce, Sm, Eu, Gd, Tb, Dy, Ho, Er, Tm, Yb, Lu, Sc, and Y) as alloying agents in the presence of carbon and a source of a reactant element including one or more of silicon, germanium, tin, lead, arsenic, antimony and bismuth to form a rare earth element-containing intermediate alloy as a master alloy for making permanent magnet material. The process is a more efficient, lower cost and environmentally friendly technology than current methods of manufacturing rare earth metals. The intermediate material is useful as a master alloy for making a permanent magnet material comprising at least one of neodymium and praseodymium, and possibly other rare earth metals as alloying additives.

This application claims benefits and priority of U.S. provisional application Ser. No. 61/280,198 filed Oct. 30, 2009, the disclosure of which is incorporated herein by reference.

### CONTRACTUAL ORIGIN OF THE INVENTION

This invention was made with government support under Contract No. DE-AC02-07CH11358 awarded by the Department of Energy. The Government has certain rights in the invention.

### FIELD OF THE INVENTION

The present invention relates to rare earth element-containing permanent magnet materials and to a method of making the materials by carbothermic reduction of a rare earth element-containing oxide including at least one of neodymium and praseodymium in a manner to form a rare earth element-containing intermediate alloy material as a master alloy for reacting with suitable non-rare earth metal alloying elements and boron and/or carbon to make a permanent magnet material at lower cost with improved properties.

### BACKGROUND OF THE INVENTION

A world-wide market ($4.3 billion) for the Nd₂Fe₁₄B-based permanent magnets is now well established, but the costs of these magnets has risen quite rapidly because the price of neodymium has risen by a factor of five times in the past three years due to Chinese export controls and pricing. Thus a new and more economical process for their preparation is very attractive, and if it were environmentally friendly this would be a plus.

Currently, the Nd₂Fe₁₄B alloy is prepared by melting the three alloy constituents in the appropriate amounts. The costliest Nd (neodymium) constituent is prepared from the oxide, Nd₂O₃, by converting it to NdF₃ and then reducing the fluoride electrolytically in a fused LiF bath. This process is quite costly since several steps are required and each involves a high consumption of electrical power. Furthermore, fluorine gas is a by-product which presents a serious environmental problem. This combined with the large amount of energy used in processing accounts for a rapid increase in the price of Nd metal in the past several years.

Nd metal also can be prepared by the metallothermic reduction of NdCl₃ or NdF₃ using calcium metal as the reductant followed by a separate casting step to remove excess calcium. In these processes, CaCl₂ or CaF₂ slag is produced and must be adequately and safely returned to the environment. The chloride process also presents a second problem as a result of residual chlorine being incorporated in the Nd metal and into Nd₂Fe₁₄B permanent magnet material made using the Nd metal. The presence of the chlorine ion in Nd₂Fe₁₄B renders the product susceptible to corrosion and oxidation such that the product must be protected by a coating from the ambient environment to prevent degradation of the permanent magnet.

### SUMMARY OF THE INVENTION

The present invention provides in an embodiment a carbothermic reduction method wherein a rare earth element-containing oxide including at least one of neodymium (Nd) and praseodymium (Pr), and optionally one or more other rare earth elements (including one or more of La, Ce, Sm, Eu, Gd, Tb, Dy, Ho, Er, Tm, Yb, Lu, Sc, and Y which are alloying agents to modify the magnetic properties of the permanent magnet material) is reduced in the presence of carbon and a source comprising a reactant element selected from the group consisting of silicon (Si), germanium (Ge), tin (Sn), lead (Pb), arsenic (As), antimony (Sb) and bismuth (Bi) to form a rare earth element-containing intermediate alloy material. This intermediate alloy is useful as a master alloy for making a permanent magnet material. The source of the reactant element can comprise elemental silicon, germanium, tin, lead, arsenic, antimony, and/or bismuth, or the oxides thereof, or other compounds thereof, that can participate in the carbothermic reduction reaction to form the intermediate material.

Moreover, the carbothermic reduction method of the invention can provide for an efficiency of greater than 90% and is also environmentally friendly since no slag is formed during preparation, and the only by-product is carbon monoxide gas, which it utilized as a starting material for preparing organic compounds, or as a component of producer gas (also known as water gas) for cogeneration of heat or electricity.

The present invention provides in another embodiment a method wherein the rare earth element-containing intermediate alloy material (as a master alloy) is reacted with one or more suitable non-rare earth metal alloying elements and boron and/or carbon to make a permanent magnet material. The permanent magnet material can include, but is not limited to, Nd₂Fe₁₄B+Si material, Pr₂Fe₁₄B+Si material, (Nd/Pr)₂Fe₁₄B+Si material wherein the materials exhibit useful magnetic remnant magnetization and coercivity properties comparable to those of commercial Nd₂Fe₁₄B permanent magnets and improved corrosion and oxidation resistance.

In an illustrative embodiment of the invention, the permanent magnet material can be represented by RₓTM_{y}B_{1-z}C_{z}+E where R is includes at least one of Nd and Pr and optionally one or more rare earth elements selected from the group consisting of La, Ce, Sm, Eu, Gd, Tb, Dy, Ho, Er, Tm, Yb, Lu, Sc, and Y; TM is selected from the group consisting of Fe, Co, V, Nb, Ti, Zr, Al, and Ga; B and C are boron and carbon respectively; and where E is a reactant element selected from the group consisting of silicon, germanium, tin, lead, arsenic, antimony and bismuth. The value of x can range from 1.5 to 2.5, the value of y can range from 12 to 16, and the value of z can range from 0 to 0.5. The ratio of the aggregate amount (e.g. aggregate atomic %) of RₓTM_{y}B_{1-z} C_{z} to the amount (atomic %) of E preferably is 2 or greater. The permanent magnet materials may be processed by any suitable means to achieve the microstructure required for optimal magnetic properties such as the coercivity, remanence, energy product and magnetic ordering temperature. One process involves making particulates comprising the permanent magnet material and bonding the particulates using a binder to form a bonded permanent magnet.

The present invention is advantageous in that the rare earth element-containing intermediate alloy is used as a master alloy to make a permanent magnet material in a single step process wherein the above-described intermediate alloy is reacted with one or more non-rare earth metals (e.g. Fe) and boron and/or carbon. Still further, the reactant element, such as silicon, can be present in the permanent magnet material in an amount effective to improve corrosion and oxidation resistance in ambient environments as compared to the same material without the reactant element.

Other advantages of the present invention will become more readily apparent from the following detailed description taken in conjunction with the following drawings.

### BRIEF DESCRIPTION OF THE DRAWINGS

FIG. 1 shows a NdSi particle of the approximate Nd:Si ratio of 5:3.5 obtained from a carbothermic-silicide reduction of Nd₂O₃ similar to the process described in Example 2.

FIG. 2 is a schematic drawing of the reduction crucible with a floating lid to reduce the loss of Nd metal due to volatization.

FIGS. 3 and 4 are B—H magnetization curves for permanent magnet materials represented by Nd₂Fe₁₄B+Si made pursuant to exemplary embodiments of the invention compared with Si-free Nd₂Fe₁₄B materials.

FIGS. 5a and 5b show the transmission electron microscopic (TEM) micrograph of Nd₂Fe₁₄B melt spun ribbon described in Example 5 at two different magnifications and FIG. 5c shows the electron diffraction pattern for the ribbon.

FIG. 6 is a plot of the second quadrant B—H magnetization curves for the first Nd₂Fe₁₄B ribbons prepared from Nd metal prepared by the carbothermic-silicide method. Also shown as a comparison are the B—H curves for a speaker magnet and a spindle magnet from a laptop computer.

FIG. 7 is a photograph of the first bonded magnet prepared from Nd metal prepared by the carbothermic-silicide process.

FIG. 8 shows the influence of the quenching wheel speed for preparing Nd—Fe—B—Si ribbons (sample no. FRS-43-154; KAA-1-66).

FIG. 9 shows the improvements in the energy product in Nd—Fe—B—Si as a function of the amount of TiC, which is a grain refiner for ribbon samples annealed at the temperature and time shown.

FIG. 10 illustrates the improvement in the energy product as the Si content in the Nd₂Fe₁₄B material is reduced for ribbon samples annealed at the temperature and time shown.

### DETAILED DESCRIPTION OF THE INVENTION

The present invention provides in an embodiment a carbothermic reduction method for reducing a rare earth element-containing oxide including at least one of neodymium (Nd) and praseodymium (Pr) at temperatures below 1800 degrees C. The rare earth element-containing oxide is reduced in the presence of carbon (reducing agent) and a source comprising a reactant element selected from the group consisting of silicon (Si), germanium (Ge), tin (Sn), lead (Pb), arsenic (As), antimony (Sb) and bismuth (Bi) in order to form a rare earth element-containing intermediate alloy material that comprises at least one of Nd and Pr, and optionally other rare earth elements selected from the group consisting of La, Ce, Sm, Eu, Gd, Tb, Dy, Ho, Er, Tm, Yb, Lu, Sc, and Y (as alloying agents to modify the magnetic properties of the permanent magnet material) and the reactant element (Si, Ge, Sn, Pb, As, Sb and/or Bi). For purposes of illustration but not limitation, when silicon (Si) comprises the reactant element, the intermediate alloy material can comprise an alloy of Nd and/or Pr and Si, such as a binary NdSiₓ or PrSiₓ alloy or a ternary (NdPr)Siₓ alloy where the value of x depends upon the carbothermic reduction reaction conditions. The alloy can be substantially stoichiometric such as Nd₅Si₃, Nd₅Si₄, Pr₅Si₃ or Pr₅Si₄, which thus comprise intermetallic compounds, or it can be non-stoichiometric such as for example, Nd₅Si_{3.62} and others as well. The rare earth element-containing intermediate alloy provides a master alloy for making a permanent magnet material as will be described below.

The carbothermic reduction process is a solid state, diffusion controlled process and intimate contact between the carbon reducing agent and the oxide particles and source of reactant element is employed for the reduction to reach completion. The optimum particle size of the rare earth-containing oxide, carbon, and source of the reactant element and the best conditions for milling and blending the mixture thereof can be determined empirically to this end. The Examples below illustrate certain exemplary parameters for carrying out the carbothermic reduction reaction.

For purposes of illustration and not limitation, the rare earth element-containing oxide can comprise suitable oxide particulates that include Nd oxide, Pr oxide, mixtures thereof, or mixed Nd/Pr oxides and optionally other rare earth oxides or mixtures thereof when the other rare earth elements noted above are to be optionally present in the intermediate alloy. For example, Nd₂O₃, and/or Pr₆O₁₁ (or an oxide in the range from Pr₂O₃ to PrO₂), and the mixed oxide Nd₂O₃ and PrOₓ (where 1.50≦x≦2.00) particulates thereof can be used in practice of the invention and are available as commercial grade, high purity oxide particles (purity of 99.9%) in a size range of 40 to 200 μm from Santoku America Company.

The carbon used as the reducing agent in the carbothermic reduction reaction can be of any suitable type, such as including but not limited to, Shawinigan (acetylene black) type available from Chevron Chemical Co. that is 100% compressed, 325 mesh, and contains less than 0.05% ash and can be used as-received. The Examples described below used such carbon in the “as-received” condition. Other types of carbon that can be used include, but are not limited to acetylene black type.

The source of the reactant element can be selected from elemental silicon, elemental germanium, elemental tin, elemental lead, elemental arsenic, elemental antimony and/or elemental bismuth as well as alloys thereof one with another and/or with other elements, one or more oxides thereof, or other compounds thereof that can participate in the carbothermic reduction reaction to form the intermediate alloy material enriched in Nd and/or Pr. For purposes of illustration and not limitation, suitable Si is available as commercial grade particles having high purity (e.g. 99.9% purity) in a size range of 100 to 250 μm from Arco Solar Company. SiO₂ is available as commercial grade silica particles having high purity (e.g. 99.9% purity) in a size range of 40 to 50 μm from Alfa-Aesar Company.

In an embodiment of the invention, a particulate mixture of the rare earth element-containing oxide, carbon reducing agent, and the source of reactant element is prepared by milling the particles and blending them together. The mixture is then formed into a paste by adding a binder in a solvent carrier to the mixture. The paste then can be formed into cubes (or other shaped bodies) and air dried to form briquettes, which have good strength and are easily loaded into the tantalum, Al₂O₃ or other reduction crucible. The dried briquettes can be heated in a tungsten resistance or other type of furnace under vacuum to an appropriate temperature at or above the onset temperature of the carbothermic reduction reaction and for a time to complete the reduction reaction to form the intermediate alloy comprising Nd and/or Pr and possibly other optional rare earth elements, and the reactant element (Si, Ge, Sn, Pb, As, Sb and/or Bi). The reaction can be monitored using a quadrupole gas analyzer to monitor by-product gases such as CO. The particulate mixture preferably is heated to the liquid or molten state after the carbothermic reduction reaction is completed to allow the oxygen and carbon time to react and form CO, thereby reducing the oxygen and carbon content of the intermediate alloy material to a relatively low content such as about 1.5 weight % of O and C or less for purposes of illustration and not limitation.

The intermediate alloy material has a controlled content of Si or other reactant element so that the Si or other reactant element content of the final permanent magnet material made using the intermediate alloy does not degrade magnetic properties and also has a beneficial effect of increasing corrosion and oxidation resistance of the permanent magnet material.

Furthermore, the carbothermic-silicide reduction method of the invention is environmentally friendly since no slag is formed during preparation, and the only by-produce is carbon monoxide gas, which can be absorbed or ignited to carbon dioxide; or utilized as a starting material for preparing organic compounds, or as a component of producer gas (also known as water gas) for cogeneration of heat or electricity. In addition the process is quite efficient, yields as high as 95% have been realized.

Pursuant to another embodiment of the present invention, the rare earth element-containing intermediate alloy is used as a master alloy in making a permanent magnet material. For purposes of illustration and not limitation, the intermediate alloy is reacted with one or more suitable non-rare earth metal alloying elements, and boron and/or carbon to make a permanent magnet material comprising a rare earth element including one or both of Nd and Pr and possibly other optional rare earth alloying additives, the non-rare earth metal, boron and/or carbon, and the reactant element selected from the group consisting of silicon, germanium, tin, lead, arsenic, antimony and bismuth in controlled concentration. The non-rare earth metal preferably comprises Fe yet the invention envisions replacing some or much of the Fe with one or more other non-rare earth metals selected from the group consisting of Co, V, Nb, Ti, Al, and Ga.

For purposes of illustration and not limitation, the present invention can be practiced to make a permanent magnet material that includes, but is not limited to, Nd₂Fe₁₄B+Si material, Pr₂Fe₁₄B+Si material, (Nd/Pr)₂Fe₁₄B+Si material when the non-rare earth metal is Fe and the reactant element is Si. The amount of Si (or other reactant element) is controlled within the range of about 1 to about 10 atomic %, preferably about 2 to about 6 atomic %, or so that the resulting permanent magnet materials exhibit useful magnetic coercivity and magnetic remanence properties comparable to ordinary grade Nd₂Fe₁₄B magnet, and improved corrosion and oxidation resistance. That is, the inclusion of Si or other reactant element does not degrade the magnetic properties of the permanent magnet material produced pursuant to the invention and is included in an amount effective to increase its corrosion and oxidation resistance in ambient environments.

In an illustrative embodiment of the invention, the permanent magnet material can be represented by RₓTM_{y}B_{1-z}C_{z}+E where R includes at least one of Nd and Pr and optionally other rare earth elements selected from the group consisting of La, Ce, Sm, Eu, Gd, Tb, Dy, Ho, Er, Tm, Yb, Lu, Sc, and Y; TM comprises one or more elements selected from the group Fe, Co, V, Nb, Ti, Zr, Al, and Ga; B and C are elemental boron and carbon, respectively; and where E is a reactant element selected from the group consisting of silicon, germanium, tin, lead, arsenic, antimony and bismuth. The value of x can range from 1.5 to 2.5, the value of y can range from 12 to 16, and the value of z can range from 0 to 0.5. The ratio of the aggregate amount (e.g. aggregate atomic %) of RₓTM_{y}B_{1-z}C_{z} to the amount (atomic %) of E is 2 or greater. The permanent magnet material can be made by introducing a source of the non-rare earth metal (e.g. Fe) and source of B and/or C to a molten bath of the rare earth-enriched intermediate alloy material. For purposes of illustration and not limitation, for making a Nd₂Fe₁₄B+Si material, Pr₂Fe₁₄B+Si material, (Nd/Pr)₂Fe₁₄B+Si material, appropriate amounts of iron and boron can be introduced into the melted intermediate Nd/PrSiₓ master alloy to make the above permanent magnet materials. Electrolytic iron and commercial grade ferro-boron can be added in the appropriate stoichiometry to form the Nd₂Fe₁₄B+Si using a partitioned crucible or added using a vibrating hopper attached to the reduction/casting furnace for purposes of illustration and not limitation.

Particular permanent magnet materials of the invention can be represented (Nd₁₋ₓRₓ)TM₁₄X+E; (Pr₁₋ₓRₓ)TM₁₄X+E; and [(Nd/Pr)₁₋ₓRₓ]TM₁₄X+E where R is optional and selected from the group consisting of La, Ce, Sm, Eu, Gd, Tb, Dy, Ho, Er, Tm, Yb, Lu, Sc, and Y; where TM is selected from the group consisting of Fe, Co, V, Nb, Ti, Al, and Ga; where X is at least one of B and C; where E is selected from the group consisting of Si, Ge, Sn, Pb, As, Sb and Bi; and x is 0 to 0.6.

The molten permanent magnet material can be melt spun to ribbon, atomized by various techniques to form generally spherical or other shape atomized particles, cast to ingot shape and pulverized to powder particles, and otherwise treated to provide various forms of the material for subsequent use in producing a permanent magnet shape. The permanent magnet materials can be heat treated to optimize their magnetic properties as described below. The invention envisions in a further embodiment making particulates comprising the permanent magnet material by melt spinning, atomization, and pulverizing, heat treating, and bonding the particulates using a binder to form a bonded permanent magnet. The invention also envisions in another further embodiment making particulates comprising the permanent magnet material as described and sintering the particulates to form a sintered permanent magnet.

The following Examples are offered to further illustrate practice of the invention but not limit the scope of the invention.

### Example 1

This example illustrates conduct of the carbothermic reduction process using silica (SiO₂) to prepare a Nd₅Si_{3.5} intermediate alloy material.
Reduction Mixture (designated FRS-42-247RC) comprised:
   49.9906 g Nd2O3 (-212 μm powder)
   12.4975 g SiO2 (−212 μm powder)
   10.0909 g C (−44 μm powder) 97.5% stoichiometry
   where −212 μm or −44 μm powder means that the particles have a particle size less than 212 μm or 44 μm, respectively.

The respective Nd₂O₃ and SiO₂ particulates are first dried separately at 800 degrees C. in air to remove any adhering moisture, non-oxidized material and/or absorbed gases and screened to the size listed, −212 μ. The mixture was blended for 2 hours in a Turbula commercial blender, mixed with ˜50 cc of acetone containing 3 wt. % polypropylene carbonate (binder), manually formed into ˜1.3 cm cube briquettes, and air dried overnight.
35.5 g of these briquettes were placed in a tantalum crucible and heated under vacuum in a tungsten resistance furnace under mechanical vacuum pumping (no diffusion pump). Heating schedule as was follows:
   heat to 1275° C. for 18 minutes
   heat to 1400° C. for 30 minutes
   heat to 1500° C. for 80 minutes
   heat to 1700° C. for 6 minutes
   cooled to 1580° C. for 12 minutes
   cooled to room temperature

The maximum pressure obtained in the furnace was ˜600 μ@ 1500° C.

The alloy had as-melted a carbon and oxygen content of C=1.69 wt. % and 0=1.31 wt. % and had a 35.6% weight loss. This amount, which exceeded the theoretical value of 32.9% for the removal of C and O, was due to vaporization of SiO and a small amount of Nd or NdO.

### Example 2

This example illustrates conduct of the carbothermic reduction process using elemental silicon (Si) to prepare a Nd₅Si_{3.5} intermediate alloy material.
Reduction Mixture (designated FRS-43-43RC) comprised:
   50.0003 g Nd₂O₃ (−212 μm powder)
   5.8426 g Si (−212 μm+125 μm powder)
   5.2471 g C (−44 μm powder) 98% stoichiometry

The Nd₂O₃ particulates are first dried at 800 degrees C. in air to remove any adhering moisture, non-oxidized material and/or absorbed gases and screened to the size listed, −212 μm. The mixture was blended for 2 hours in Turbula commercial blender, mixed with ˜45 cc of acetone containing 3 wt. % polypropylene carbonate (binder), manually formed into ˜1.3 cm cube briquettes, and air dried overnight.
33.1 g of these briquettes were placed in a tantalum crucible and heated in a tungsten resistance furnace under mechanical vacuum pumping (no diffusion pump). Heating schedule was as follows:
   heat to 1375° C. for 60 minutes
   heat to 1425° C. for 60 minutes
   heat to 1500° C. for 60 minutes
   heat to 1700° C. for 12 minutes
   heat to 1600° C. for 60 minutes
   cooled to room temperature

The maximum pressure obtained in the furnace was ˜600 μm @ 1500° C. plus.

The alloy had as-melted carbon and oxygen contents of C=1.03 wt. % and 0=0.73 wt. % and had a 26.6% weight loss (theoretical 20.3%).
17.8136 g of this alloy were placed in a tantalum crucible and heated as alloy FRS-43-110/62RC (Nd) to 1750° C. for 15 minutes using both mechanical and diffusion pumping.
   weight loss was 0.145 wt. %
   C=0.69 wt. %
   0=0.65 wt. %

From SEM analysis this alloy had the composition of Nd₅Si_{3.62} and was used to prepare the Nd₂Fe₁₄B+Si alloy CEA-1-55 in the next Example.

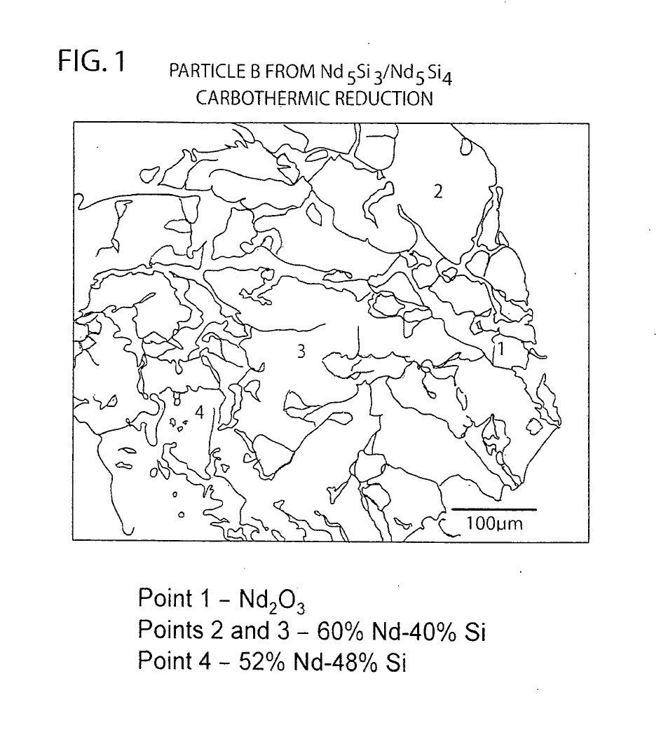

FIG. 1 shows a NdSi particle of the approximate Nd:Si ratio of 5:3.5 obtained from such a carbothermic-silicide reduction of Nd₂O₃ particles. The NdSi particle can be melted and alloyed with a non-rare earth element, such as Fe, and boron and/or carbon without further treatment of the particle. That is, the region of Nd₂O₃ in the particle does not require removal since the amount of oxygen present in the NdSi particle as a result of the presence of the oxide region is small on the order of 1 to 2 weight %.

### Example 3

This example illustrates the conduct of the carbothermic process using elemental silicon (Si) and compacting the prepared briquettes into wafer form. The compacted wafers occupy only one-third the volume of the briquettes and consequently much more material can be processed in the reduction step. A Nd₅Si_{3.52} intermediate alloy was prepared.
Reduction Mixture (designated FRS-43-15IRC) comprised:
   50.0004 g Nd₂O₃ (−212 μm powder)
   5.0075 g Si (−212 μm+125 μm powder)
   5.2198 g C (−44 μm powder) 97.5% stoichiometry

The Nd₂O₃ particulates are first dried at 800° C. in air to remove any adhering moisture, non-oxidized material and/or absorbed gases and screened to −212 μm. The mixture was blended for 2 hours in Turbula commercial blender, mixed with ˜40 cc of acetone containing 3 wt. % polypropylene carbonate (binder), manually formed into ˜1.3 cm cube briquettes, and air dried overnight. These briquettes were compacted into 2.5 cm diameter by ˜0.4 cm thick round wafers using a conventional harden right angle cylinder die and ram. Approximately 1.0×10³ kg/cm² pressure was used to form the wafers. Two or three briquettes were used to prepare each wafer.
31.4 g of these wafers were placed in a tantalum crucible and heated in a tungsten resistance furnace under mechanical vacuum pumping, no diffusion pump was used through the 1540° C. heat for 90 minutes. After this time the diffusion pump was valved into the system and heating to 1760° C. was resumed. Heating schedule was as follows:
   heat to 1100° C. for 6 minutes
   heat to 1400° C. for 6 minutes
   heat to 1540° C. for 90 minutes
   heat to 1760° C. for 10 minutes
   cooled to room temperature

The maximum pressure obtained in the furnace was ˜470 μm at 1540° C. plus. The alloy was shiny, had been molten and no reaction was noted when a sample was placed in water for 72 hours indicating very little or no neodymium carbide phase present. The as-prepared alloy had carbon and oxygen contents of C=1.11 wt. % and 0=0.91 wt. %. An 86.6% yield of Nd was obtained and the alloy had a calculated composition of Nd₅Si_{3.52}.

### Example 4

This example illustrates conduct of the carbothermic reduction process using elemental silicon (Si) to prepare a Nd₅Si_{3.22} intermediate alloy material using a tantalum reduction crucible with a floating lid to enhance the yield of alloy.
Reduction Mixture (designated FRS-43-200RC) comprised:
   50.0007 g Nd₂O₃ (−212 μm powder)
   5.0078 g Si (−125 μm powder)
   5.3533 g C (−44 μm powder) 100% stoichiometry

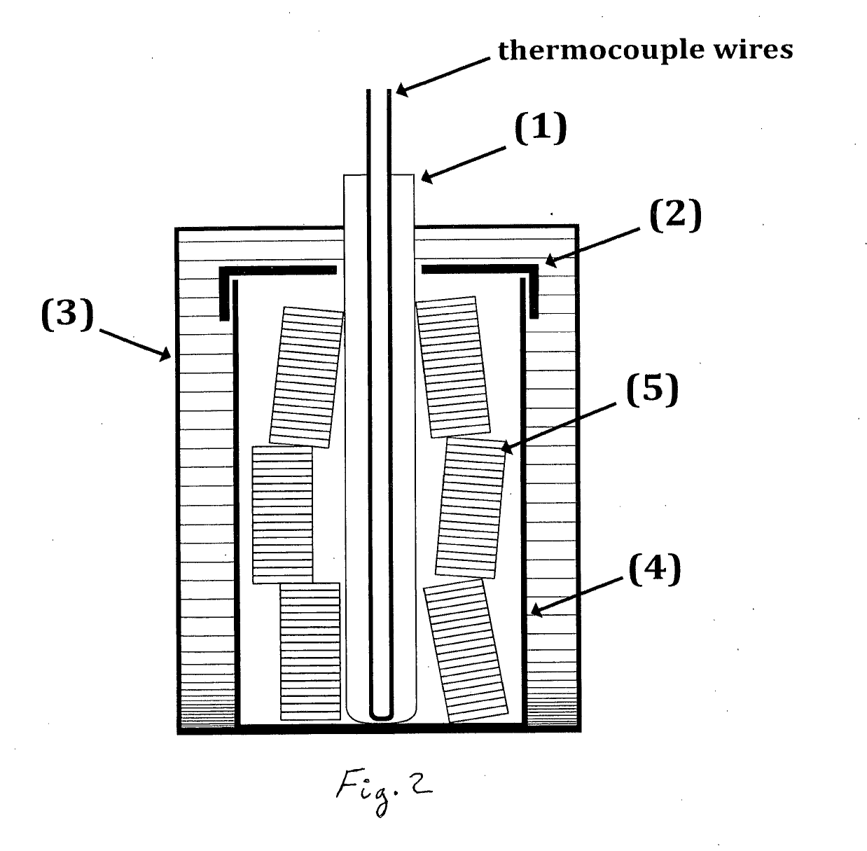

The Nd₂O₃ particulates are first dried at 800° C. in air to remove any adhering moisture, non-oxidized material and/or absorbed gases and screened to −212 μm. The mixture was blended for 2 hours in Turbula commercial blender and 40 grams were mixed with ˜27 cc of acetone containing 3 wt. % polypropylene carbonate (binder), manually formed into ˜1.3 cm cube briquettes, and air dried overnight. These briquettes were compacted into 1.58 cm diameter by ˜0.4 cm thick round wafers using a conventional harden right angle cylinder die and ram. Approximately 2.1×10³ kg/cm² pressure was used to form the wafers. One or two briquettes were used to prepare each wafer.
Six of these wafers weighing 20.2 g were placed in a 2.54 cm diameter tantalum crucible having a 0.6 diameter thermocouple well in the center and a loose fitting tantalum lid that would rise from the crucible when CO was emitted from the reaction and then fall and cover the crucible to minimize the loss of neodymium due to volatilization. A schematic of this arrangement is shown in FIG. 2 which illustrates tantalum thermocouple well 1 containing W/26% Re-W/5% Re Type C thermocouple, loose fitting tantalum lid 2, tantalum backing crucible 3, main tantalum reaction crucible 4, and 1.58 cm diameter by about 0.4 cm thick compacted wafers 5. This assembly was heated in a tungsten resistance furnace under vacuum (using both a mechanical pump and a diffusion pump) through the entire heating schedule. Heating schedule was as follows:
heat to 1100° C. for 6 minutes
heat to 1400° C. for 6 minutes
heat to 1540° C. for 120 minutes
heat to 1780° C. for 15 minutes
cooled to room temperature

The maximum pressure obtained in the furnace was ˜230 μm at 1540° C. plus. Fluctuation in the pressure was observed during the reduction step due to the raising and lowering of the floating lid over the crucible.

The alloy was shiny, had been molten, and a sample did not react in water after 72 hours indicating little or no neodymium carbide present. The yield of neodymium was 94% and the alloy had carbon and oxygen contents of C=1.42 wt. % and O=0.79 wt. %. The alloy had a calculated composition of Nd₅Si_{3.22}.

### Example 5

This example illustrates preparation of Nd₂Fe₁₄B+Si from the Nd₅Si_{3.62} alloy (CEA-1-55) above as follows:
10.000 g Nd₅Si_{3.62} [designated FRS-43-110/62RC (Nd)]
2.1150 g FeB
21.9658 g Fe

The above components were arc-melted together under argon on a cold copper hearth. The resultant ingot had a composition of 25.71 wt. % Nd, 69.69 wt. % Fe, 0.96 wt. % B+3.62 wt. % Si. The ingot was then melt spun at 20 m/sec to form ribbon which was sealed in quartz under Ar and annealed for 20 minutes at 800° C. and then quenched in an ice bath (designated as CEA-1-55).

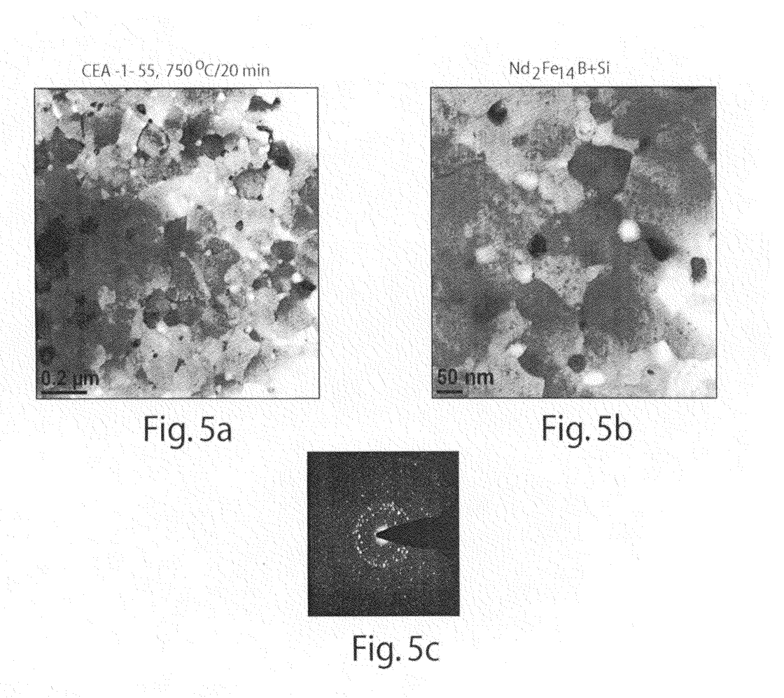

FIGS. 5a and 5b shows a transmission electron microscopic (TEM) micrograph of Nd₂Fe₁₄B melt spun ribbon similarly melt spun and annealed at 750 degrees C. for 20 minutes, removed from the furnace and quenched in an ice bath at two different magnifications and FIG. 5c shows the electron diffraction pattern for the ribbon.

The magnetic measurement results after the heat treatment were as follows: remnant magnetization=7.1 kG; coercivity=2.7 kOe; and energy product (BHₘₐₓ)=6.1 MG-Oe These measured properties are similar to those of the lowest commercial grade Nd₂Fe₁₄B permanent magnets.

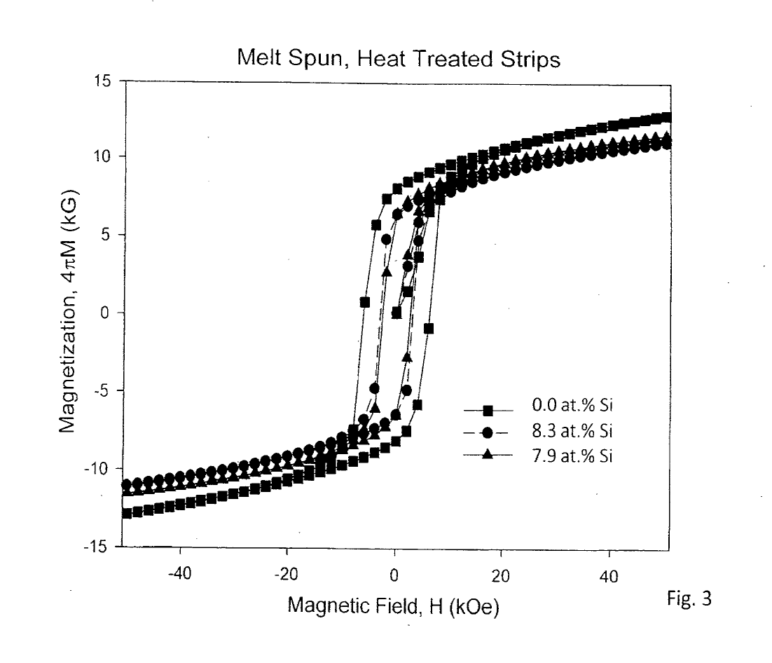

More generally, the melt spun ribbons can be heat treated at 650 to 850 degrees C. for 10 to 30 minutes to develop optimum magnetic properties. The optimum heating temperature for Nd₂Fe₁₄B+Si ribbons is higher than that of the material without Si. FIG. 3 shows the B—H magnetization curve for the 7.9 at. % Si alloy (CEA-1-55) after heat treatment. Also shown are the B—H curves for the Nd₂Fe₁₄B samples containing 0.0 at. % Si (FRS-43-50) and 8.3 at. % Si (FRS-43-54).

The arc-melted samples containing Si exhibited superior oxidation resistance compared to an arc-melted material without Si. For example, after 64 days at 300 degrees C., the Si-containing material (CEA-1-55) pursuant to the invention is six (6) times more resistant based on weight gain.

### Example 6

This example illustrates preparation of Nd₂Fe₁₄B+Si where the content of Si is varied to determine affect on magnetic properties. Samples of Nd₂Fe₁₄B+0% Si, 2% Si, 3% Si, 4% Si, and 5% Si where % is weight % were made by alloying the elements in an arc-melting step, and heat treating in a manner similar to that described above.

FIG. 3 shows B—H magnetization curves for samples with 0 at. % Si (control sample) and 8.3 at. % Si, and the CEA-1-55 material of Example 5 (7.9 at. % Si).

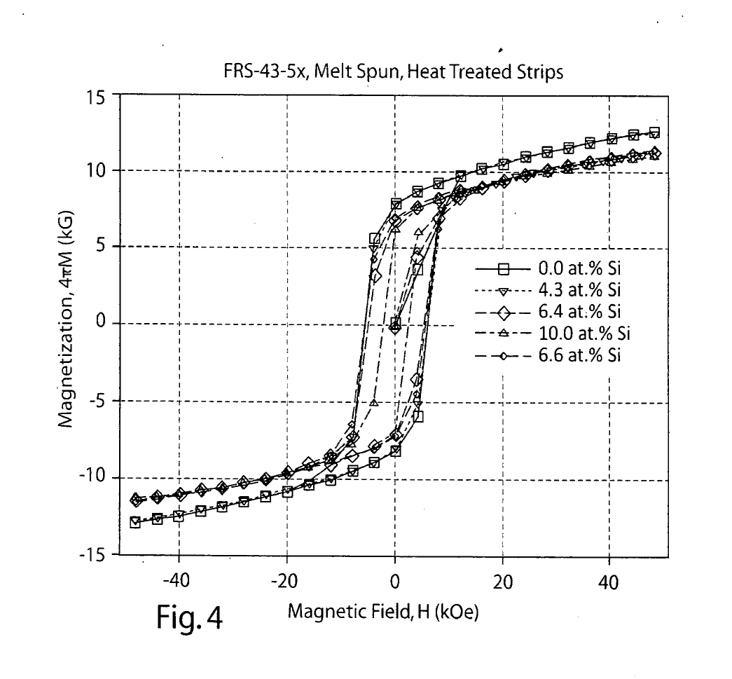

FIG. 4 shows B—H magnetization curves for samples with 0 at. % Si, 4.3 at. % Si, 6.4 at % Si, and 10.0 at. % Si and sample AGY-260R which is 6.6 at. % Si.

FIG. 3 reveals that the NdFeB permanent magnet material (CEA-1-55, 7.9 at. % Si) prepared as described in Example 5 has magnetic properties nearly the same as an alloy with a Si content of 8.3 at. %.

FIG. 4 reveals that Si contents from 4.3 (FRS-43-52) to 6.6 at. % (AGY-260R) do not adversely affect the magnetic properties of the NdFeB permanent magnet material, but some degradation is noted when 10.0 at. % (FRS-54-55) Si is added. Also shown are the B—H curves for NdFeB alloys without Si (FRS-43-50) and 6.4 at. % Si (FRS-43-53).

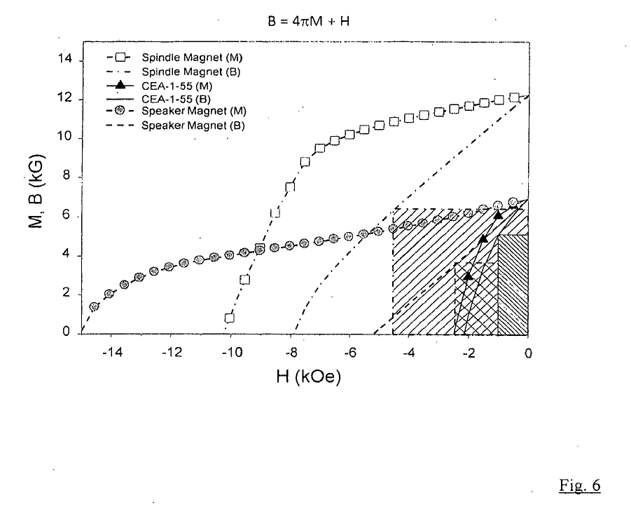

A better comparison of the permanent magnet properties of the Nd—Fe—B—Si product prepared from the Nd—Si metallic alloy produced by using the carbothermic-silicide method is the energy product calculated from the B—H curves in the second quadrant, see FIG. 6. BHₘₐₓ is the largest area under the B vs. H curve in the second quadrant, and illustrated as the boxes under the respective curve. As seen the energy product of the first ribbons (CEA-1-55) prepared from the carbothermic-silicide Nd metal is comparable to that of a speaker magnet in a laptop computer, which is a bonded magnet manufactured from Nd—Fe—B ribbons. The energy product for the spindle magnet is significantly larger because it is a sintered magnet, and sintered magnets always have much larger energy products than bonded magnets.

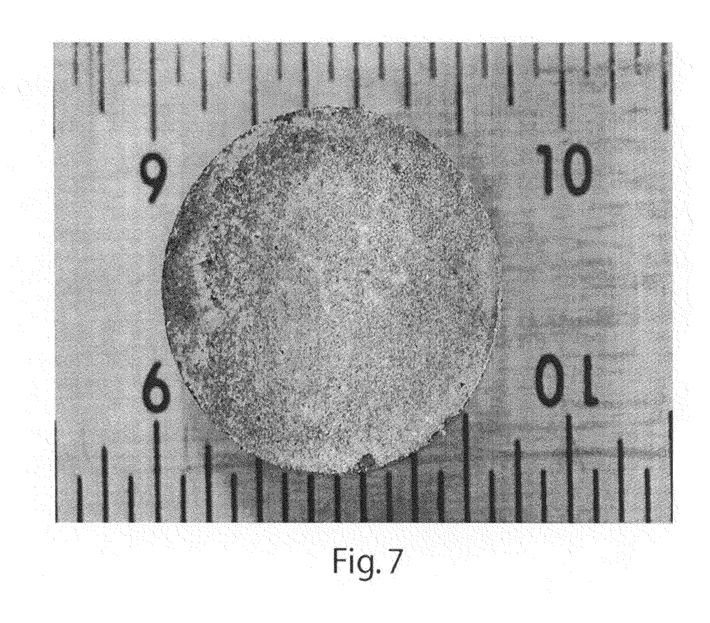

FIG. 7 is a photograph of the first bonded magnet produced from the Nd—Si start material ribbons prepared by the carbothermic-silicide process. The ribbons were heat treated for 20 minutes at 750° C., cooled, crushed, then the metallic particles were mixed with polyphenylene sulfide (PPS) in a 60 (NdFeBSi) to 40 (PPS) volume percent ratio, and simultaneously hot pressed at 300° C. and magnetized in a 20 kOe field.

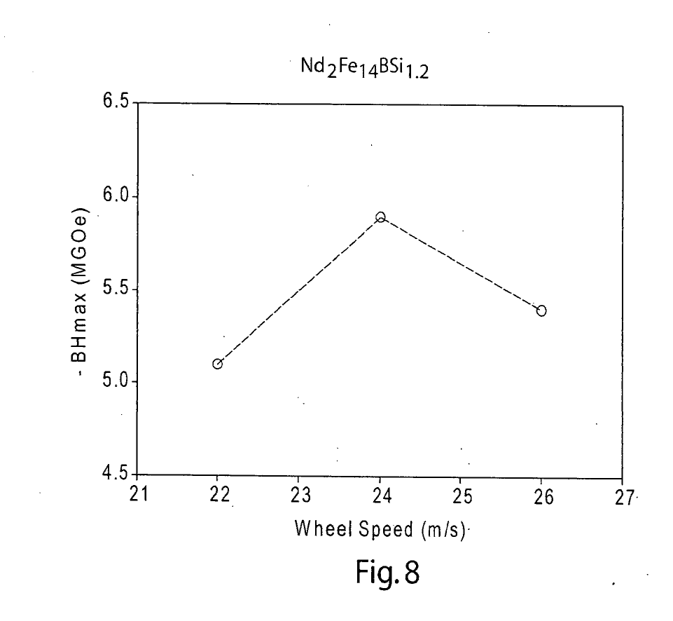

The rate at which the Nd—Fe—B—Si material is quenched has a pronounced affect on the grain size of the magnetic material in the ribbons. FIG. 8 shows that quenching the Nd—Fe—B—Si alloy at a wheel speed of 24 m/s yield ribbons with the highest energy product compared to ribbons that were obtained using wheel speeds of 22 and 26 m/s.

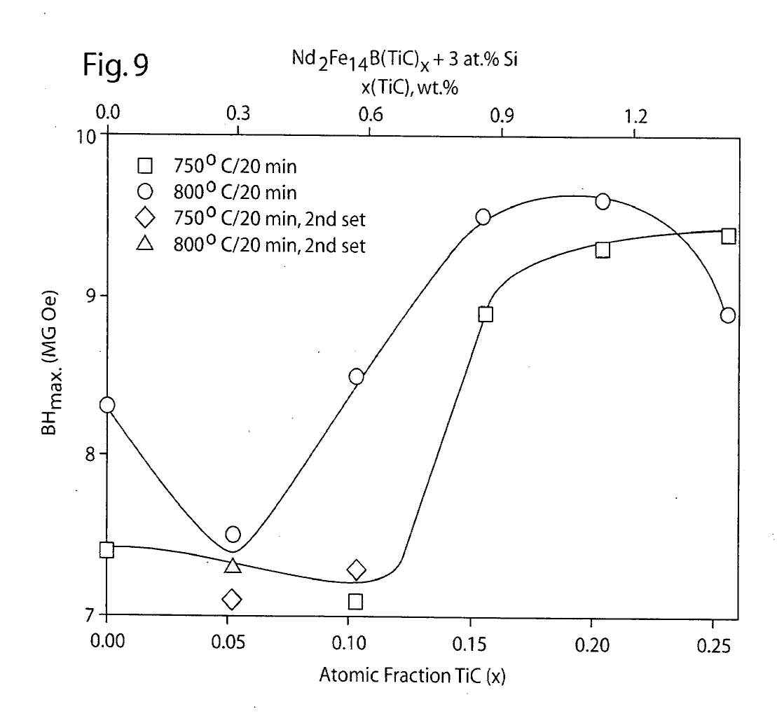

TiC has been known as a grain refining agent to refine the Nd—Fe—B grain size in the rapidly solidified ribbons. The influence of TiC in the Nd—Fe—B—Si alloys is illustrated in FIG. 9. It is seen that the addition of about two-tenths of an atomic fraction (or about 1.0 weight percent) TiC increases the energy product of the Nd—Fe—B—Si material by about 33%.

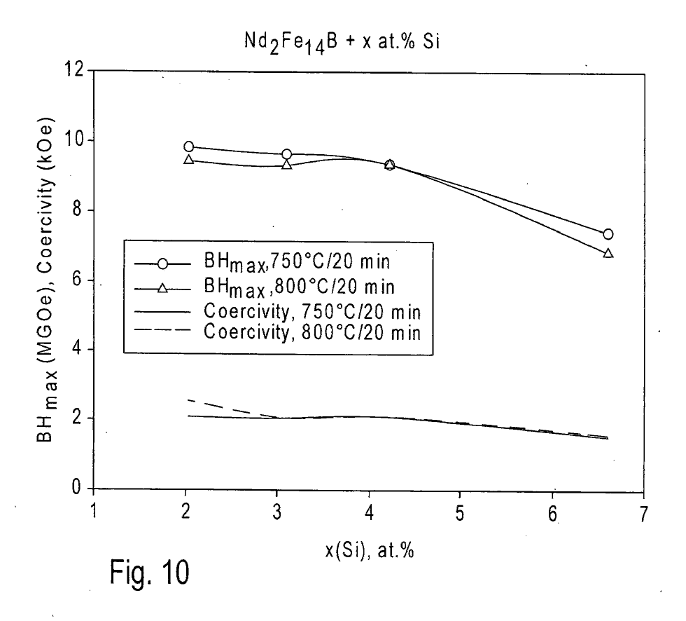

As seen in FIG. 4 the permanent magnetic properties are reduced if ˜10.0 at. % Si or more is present in the alloy. Since the starting Nd—F—B—Si permanent magnet alloy contains about 6.9 at. %, adding pure Nd metal to the NdSi material prepared by the carbothermic silicide process before alloying with Fe and B will lower Si concentration to an acceptable level to produce magnets with good BH values. The results of the addition of pure Nd to reduce the Si content is shown in FIG. 10. Reducing the Si content from ˜6.7 at. % to ˜4.5 at. % results in about a ten percent increase in the energy product. This change is accomplished by adding 3 Nd atoms per Nd₅Si₃ molecule. Lowering the Si content any further has a negligible effect.

Although the invention has been described in connection with certain illustrative embodiments, those skilled in the art will appreciate that changes and modifications can be made therein within the scope of the invention as set forth in the appended clams.

1. A method of making a rare earth element-containing intermediate alloy material for making a permanent magnet material, comprising carbothermically reducing a rare earth element-containing oxide including at least one of neodymium and praseodymium in the presence of carbon and a source comprising a reactant element selected from the group consisting of silicon, germanium, tin, lead, arsenic, antimony, and bismuth to form a rare earth-containing intermediate alloy material that comprises at least one of neodymium and praseodymium and the reactant element as a master alloy for making a permanent magnet material.

2. The method of claim 1 wherein the source of the reactant element is selected from the group consisting of elemental silicon, elemental germanium, elemental tin, elemental lead, elemental arsenic, elemental antimony, and elemental bismuth, alloys thereof with one another and/or other elements, oxides thereof, or non-oxide compounds thereof that participate as a reactant to form the intermediate material.

3. The method of claim 1 wherein the rare earth element-containing intermediate alloy material comprises an alloy comprising at least one of neodymium and praseodymium and silicon.

4. The method of claim 3 wherein the alloy comprises at least one of neodymium and praseodymium and silicon as a master alloy.

5. The method of claim 4 wherein the alloy includes 28.5 atomic % Si.

6. The method of claim 4 wherein the alloy includes 35.8 atomic % Si.

7. The method of claim 4 wherein the alloy includes 37.5 atomic % Si.

8. The method of claim 4 wherein the alloy includes 41.1 atomic % Si.

9. The method of claim 1 wherein the carbothermic reduction is initiated at a temperature of at least about 1275 degrees C.

10. A method of making a permanent magnet material, comprising reacting an alloy that comprises at least one of neodymium and praseodymium and another element selected from the group consisting of silicon, germanium, tin, lead, arsenic, antimony and bismuth with a non-rare earth metal and at least one of boron and carbon to provide a permanent magnet material comprising at least one of neodymium and praseodymium, a non-rare earth metal, at least one of boron and carbon, and the another element.

11. The method of claim 10 wherein the alloy comprises at least one of neodymium and praseodymium and silicon.

12. The method of claim 11 wherein the alloy comprises at least one of neodymium and praseodymium and silicon as a master alloy.

13. The method of claim 12 wherein the alloy includes 28.5 atomic % Si.

14. The method of claim 12 wherein the alloy includes 35.8 atomic % Si.

15. The method of claim 12 wherein the alloy includes 37.5 atomic % Si.

16. The method of claim 12 wherein the alloy includes 41.1 atomic % Si.

17. The method of claim 10 wherein the permanent magnet material contains the another element in an amount to improve its corrosion and oxidation resistance without degrading its magnetic properties.

18. The method of claim 17 wherein the permanent magnet material contains silicon in an amount to improve its corrosion and oxidation resistance without degrading its magnetic properties.

19. The method of claim 18 wherein the permanent magnet material contains about 1 to about 10 atomic % Si.

20. The method of claim 19 further including the introduction of at least one of neodymium metal and praseodymium metal to control silicon content of the permanent magnet material.

21. The method of claim 10 further comprising including a grain refining agent in the permanent magnet material.

22. The method of claim 10 wherein the alloy is melted and the non-rare earth metal and at least one of boron and carbon are introduced to the molten alloy.

23. The method of claim 10 wherein the reaction is conducted in a crucible with a floating lid.

24. The method of claim 10 further including making particulates comprising the permanent magnet material.

25. The method of claim 24 further including bonding the particulates using a binder to form a bonded permanent magnet.

26. The method of claim 24 further including sintering the particulates to form a sintered permanent magnet.

27. A method of making a permanent magnet material, comprising carbothermically reducing a rare earth element element-containing oxide including at least one of neodymium and praseodymium in the presence of carbon and a source comprising a reactant element selected from the group consisting of silicon, germanium, tin, lead, arsenic, antimony and bismuth to form a rare earth element-containing intermediate alloy that comprises at least one of neodymium and praseodymium and the reactant element and reacting the intermediate alloy with a non-rare earth metal and at least one of boron and carbon to provide a permanent magnet material comprising at least one of neodymium and praseodymium, a non-rare earth metal, at least one of boron and carbon, and the reactant element.

28. The method of claim 27 wherein the intermediate alloy comprises at least one of neodymium and praseodymium, and silicon as a master alloy.

29. The method of claim 28 wherein the alloy includes 28.5 atomic % Si.

30. The method of claim 28 wherein the alloy includes 35.8 atomic % Si.

31. The method of claim 28 wherein the alloy includes 37.5 atomic % Si.

32. The method of claim 28 wherein the alloy includes 41.1 atomic % Si.

33. The method of claim 27 wherein the permanent magnet material contains the reactant element in an amount to improve its corrosion and oxidation resistance without degrading its magnetic properties.

34. The method of claim 33 wherein the permanent magnet material contains silicon in an amount to improve its corrosion and oxidation resistance without degrading its magnetic properties.

35. The method of claim 27 wherein the intermediate alloy is melted and the non-rare earth metal and at least one of boron and carbon are introduced to the molten intermediate material.

36. The method of claim 27 further including making particulates comprising the permanent magnet material.

37. The method of claim 36 further including bonding the particulates using a binder to form a bonded permanent magnet.

38. The method of claim 36 further including sintering the particulates to form a sintered permanent magnet.

39. The method of claim 27 wherein the carbothermic reduction is initiated at a temperature of at least about 1275 degrees C.

40. A carbothermically reduced rare earth element-containing alloy that includes at least one of Nd and Pr and at least one element selected from the group consisting of silicon, germanium, tin, lead, arsenic, antimony and bismuth.

41. The material of claim 40 comprising at least one of neodymium and praseodymium, and silicon.

42. The material of claim 41 including 28.5 atomic % Si.

43. The material of claim 42 including 35.8 atomic % Si.

44. The material of claim 42 including 37.5 atomic % Si.

45. The material of claim 42 including 41.1 atomic % Si.

46. The material of claim 40 further including an element selected from the group consisting of La, Ce, Sm, Eu, Gd, Tb, Dy, Ho, Er, Tm, Yb, Lu, Sc, and Y.

47. A permanent magnet material comprising a rare earth element including at least one of Nd and Pr, a non-rare earth metal, at least one of boron and carbon, and an element selected from the group consisting of silicon, germanium, tin, lead, arsenic, antimony and bismuth in an amount effective to improve corrosion and oxidation resistance of the material.

48. The material of claim 47 wherein Si is present in an amount of about 1 to about 10 atomic %.

49. The material of claim 47 wherein the non-rare earth metal comprises Fe.

50. The material of claim 47 wherein B is present.

51. A permanent magnet material represented by RₓM_{y}B_{1-z}C_{z}+E where R is includes at least one of Nd and Pr and optionally one or more elements selected from the group consisting of La, Ce, Sm, Eu, Gd, Tb, Dy, Ho, Er, Tm, Yb, Lu, Sc, and Y; TM is selected from the group consisting of Fe, Co, V, Nb, Ti, Zr, Al, and Ga; B and C are boron and carbon respectively; and where E is a reactant element selected from the group consisting of silicon, germanium, tin, lead, arsenic, antimony and bismuth, and wherein the value of x ranges from 1.5 to 2.5, the value of y ranges from 12 to 16, and the value of z ranges from 0 to 0.5, and the ratio of the aggregate amount of RₓTM_{y}B_{1-z}C_{z} to the amount of E is 2 or greater.

52. The material of claim 51 wherein E comprises Si present in an amount of about 1 to about 10 atomic %.

53. The material of claim 51 wherein TM comprises Fe and X comprises B.

54. A permanent magnet material represented by (Nd₁₋ₓRₓ)TM₁₄X+E where R is optional and selected from the group consisting of La, Ce, Sm, Eu, Gd, Tb, Dy, Ho, Er, Tm, Yb, Lu, Sc, and Y; where TM is selected from the group consisting of Fe, Co, V, Nb, Ti, Al, and Ga; where X is at least one of B and C; where E is selected from the group consisting of Si, Ge, Sn, Pb, As, Sb and Bi; and x is 0 to 0.6.

55. The material of claim 54 wherein E comprises Si present in an amount of about 1 to about 10 atomic %.

56. The material of claim 54 wherein TM comprises Fe and X comprises B.

57. A permanent magnet material represented by (Pr₁₋ₓRₓ)TM₁₄X+E where R is optional and selected from the group consisting of La, Ce, Sm, Eu, Gd, Tb, Dy, Ho, Er, Tm, Yb, Lu, Sc, and Y; where TM is selected from the group consisting of Fe, Co, V, Nb, Ti, Al, and Ga; where X is at least one of B and C; where E is selected from the group consisting of Si, Ge, Sn, Pb, As, Sb and Bi; and x is 0 to 0.6.

58. The material of claim 57 wherein E comprises Si present in an amount of about 1 to about 10 atomic % Si.

59. The material of claim 57 wherein TM comprises Fe and X comprises B.

60. A permanent magnet material represented by [(Nd/Pr)₁₋ₓRₓ]TM₁₄X+E where both Nd and Pr are present and where R is optional and selected from the group consisting of La, Ce, Sm, Eu, Gd, Tb, Dy, Ho, Er, Tm, Yb, Lu, Sc, and Y; where TM is selected from the group consisting of Fe, Co, V, Nb, Ti, Al, and Ga; where X is at least one of B and C; where E is selected from the group consisting of Si, Ge, Sn, Pb, As, Sb and Bi; and x is 0 to 0.6.

61. The material of claim 60 wherein E comprises Si present in an amount of about 1 to about 10 atomic %.

62. The material of claim 60 wherein TM comprises Fe and X comprises B.
